(19) United States
(12) Patent Application Publication
(10) Pub. No.: US 2023/0281836 A1
(43) Pub. Date: Sep. 7, 2023

(54) OBJECT MOVEMENT IMAGING

(71) Applicant: MiiM, Inc., Sandy, UT (US)

(72) Inventors: Franz D. Busse, Salt Lake City, UT (US); Justin R. Lindsey, Salt Lake City, UT (US); Armando Guereca-Pinuelas, Cottonwood Heights, UT (US)

(21) Appl. No.: 18/117,000

(22) Filed: Mar. 3, 2023

Related U.S. Application Data
(60) Provisional application No. 63/316,792, filed on Mar. 4, 2022.

(51) Int. Cl. G06T 7/292; G06T 11/00

(52) U.S. Cl. CPC G06T 7/292; G06T 11/00; G06T 2207/10024; G06T 2207/30241

(57) ABSTRACT

The present invention extends to methods, systems, and computer program products for imaging object movement. Aspects of the invention utilize sensor input, artificial intelligence, and other algorithms to render reduced complexity visualizations of objects (e.g., graphical dots) moving in a (e.g., three dimensional) space being scanned by sensors. Automated alerts can be generated when object movements meet certain user-set criteria. Spatial and temporal analyses of object movements in the space can also be performed. Aspects of the invention, can be used for safety or security or other things like managing retail sales. Inferences about situations can be derived from monitoring one or more dots that move rapidly or slowly, or idle, or monitoring a dot in a public space or going into a restricted or dangerous area. Movement captured in sensor input (e.g., video) can be synchronized with movement in reduced complexity visualizations and viewed side-by-side.

### CROSS-REFERENCE TO RELATED APPLICATIONS

This application claims the benefit of U.S. Provisional Patent Application Ser. No. 63/316,792, entitled “Object Movement Imaging”, filed Mar. 4, 2022 which is incorporated herein in its entirety.

### BACKGROUND

### 1. Related Art

The are many environments (e.g., stadiums, arenas, malls, stores, highways, etc.) where the movement of objects, such as, people, vehicles, animals, etc. matters. Knowing and understating where objects are located and how the objects are moving in a space can help those responsible for the space plan, manage, and respond to events within the space more efficiently and effectively.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 depicts an example computer architecture that facilitates object movement imaging.

FIG. 2 depicts another example computer architecture that facilitates object movement imaging.

FIG. 3 depicts example formats for pixels, measurements, and tracks.

FIG. 4A depicts an example centralized sensor arrangement

FIG. 4B depicts an example distributed sensor arrangement.

FIG. 5 depicts an example computer architecture that facilitates object movement imaging.

FIG. 6 depicts an example logical hierarchy of movement imaging components.

FIG. 7 depicts an example computer architecture that facilitates movement extraction.

FIG. 8 depicts another example computer architecture that facilitates movement extraction.

FIG. 9 depicts example equations for calculating sensor noise covariance.

FIG. 10 depicts example equations for calculating object height.

FIG. 11 depicts example equations for calculating height of a single point.

FIG. 12 depicts an example track correlation flow.

FIG. 13 depicts example equations for distance calculations.

FIG. 14A depicts an example single camera architecture.

FIG. 14B depicts an example loosely coupled multi-camera architecture.

FIG. 14C depicts an example tightly coupled multi-camera centralized architecture.

FIG. 14D depicts an example tightly coupled multi-camera mesh architecture.

FIG. 15A depicts an example loosely coupled architecture.

FIG. 15B depicts another example loosely coupled architecture.

FIG. 16A depicts an example of a tightly coupled centralized architecture.

FIG. 16B depicts another example of a tightly coupled centralized architecture.

FIG. 17A depicts an additional example of a tightly coupled mesh architecture.

FIG. 17B depicts a further example of a tightly coupled mesh architecture.

FIG. 18 depicts an example signal processing chain for a 2D camera.

FIG. 19 depicts an example signal processing chain for a stereoscopic camera.

FIG. 20 depicts an example signal processing chain for a 2D camera with lidar.

### DETAILED DESCRIPTION

Examples extend to methods, systems, and computer program products for imaging object movement. Aspects of the invention utilize sensor input, artificial intelligence, and other algorithms to render reduced complexity visualizations of objects moving in a (e.g., three dimensional) space being scanned by sensors. Automated alerts can be generated when object movements meet certain user-set criteria. Spatial and temporal analyses of object movements in the space can also be performed.

Imaging object movement has a variety of applications. Knowing and understanding where objects are located and how they are moving in a space can help those responsible for the space plan, manage, and respond to events within the space much more effectively and efficiently. The movement of any of a variety of different objects can be imaged. For example, aspects of the invention can image the movement of people, vehicles, and animals, etc. Aspects can be used to understand the movement of objects that may not have any other signals, such as, cell phones, RFID tags, or other mechanisms for tracking or communicating with them.

Movement imaging can provide a unified view of objects, alerts based on object movement, analytics based on object movement over time, etc.

Sensors, for example, video cameras, (2D or stereoscopic), lidars, radars (including 2D or 3D radar), sonars (e.g., ultrasonic and including 2D or 3D sonar), etc., can be placed around a space to be imaged. Each sensor may have a Field of View (FoV) covering at least part of the space. In one aspect, a centralized core, either on a local server or in the cloud (such as AWS), accesses tracks from the cameras or other sensors and supports web-based or mobile app User Interfaces. In some aspects, sensors collect data and forward data to other processing components. In other aspects, sensors collect data and perform computations locally. In further aspects, sensors collect data, perform computations locally, and also forward data to other processing components. Forwarded data can include sensed data and/or results of locally performed computations.

A user interface can include a “unified view” that makes a single view out of many sensor (e.g., camera, lidar, radar, sonar, etc.) views. A unified view can include a map, or a blueprint view of a building or a space, such as, for example, a stadium, a casino, a park, a Capitol building, a school, etc. The unified view can display a map view of the space including dots (representing objects) that move on that map view in real time. These dots may have different colors, shapes, or sizes, to rapidly indicate different characteristics of that object Immediate understanding of what is happening in the space is increased by watching the motion of the dots relative to each other and to the space around them.

A unified view can be independent of cameras or other sensors. The unified view can depict the objects' movements regardless of how the object's movements were tracked. A user can click on either a space or an object, and get real-time synchronized video streams of that object. Thus, movement captured in sensor input (e.g., video) can be synchronized with movement in reduced complexity (e.g., dot) visualizations and viewed side-by-side. For example, a user can watch movement of one or more dots and select the corresponding portion of video feed on demand Thus, reduced complexity (e.g., dot) visualizations can essentially be used to search video.

Aspects of the invention, can be used for safety or security or other things like managing retail sales. Inferences about situations can be derived from seeing a dot that moves rapidly or slowly, or idles, seeing a dot in a public space or going into a restricted or dangerous area.

A user can set up a selection of (e.g., real-time) alerts based on object movement within the space. Alerts and data used to trigger alerts can vary in complexity and can include, for example: when a person enters a room, when a certain number of people in a room has been exceeded, when a person leaves one group of people and joins another group, when a person, that entered from a public door, has remained in a certain room for over a certain limit of time, when a person exceeds a certain speed limit, when a person has come into contact with at least N number of other people, etc.

The number and type of alerts can be compounded and are nearly limitless.

A user can request any number of reports or analytics based on the motion of the objects in the space over time. Analytics may be performed in post-processing. Like alerts, analytics can also vary in complexity and can include, for example: generating a track over time of where an object has traveled throughout the space over the course of a day, deriving a time history of number of people in a room over the course of a day for every minute, deriving times and locations of crowd congestion in a stadium over the course of a sport season, computing a number of objects exceeding a speed limit in a certain location over the course of a week, determining the most popular room at a venue, determining how, many people entered restricted areas during the month, etc.

Movement Imaging can excel for a variety of analytics including analytics keeping track of many objects over a large space over time: where they have been, how they have traveled the space, etc., at an object-level granularity (not just averages or trends).

Thus, in general, aspects of the invention can track objects (e.g., people, vehicles, etc.) in any (e.g., indoor) space. Aspects support human and machine analytics and may be run on using off-the shelf (and thus reasonably affordable) components.

In a more particular aspect, objects (e.g., people) can be tracked within 1 meter in a position space. Each object can be associated with a single track as long as the object is in a monitored space. A number of objects (e.g., up to hundreds of thousands) having varied appearances, sizes, shapes, types, etc. can be “tracked” across a range of speeds, poses, motions, behaviors, etc.

Aspects can operate in any arbitrary space (e.g., rooms, open areas, walls, ramps, windows, etc.) accounting for gaps in coverage (e.g., for bathrooms), and using commonly available infrastructure (e.g., communication, lighting, mounting, etc.). Aspects can provide near real-time analytics (e.g., ranging from 200 ms to 2 s) via an intuitive, robust, attractive, and powerful user interface. Big-data capability can facilitate machine analytics, for example, using tools that run over a long time history of large numbers of objects. Real-time video can also be displayed for a monitored space.

Potential implementations include using motion information as input for virtual reality applications, such as, for example, games, lifestyle, or productivity applications. For mapped movement within a space a “virtual twin” can exist in any “metaverse”, either live or from archived movement data.

In this description and the following claims, “discretization” is defined as transforming an object into a simpler representation of the object. For example, a human, animal, or vehicle depicted in a video can be transformed into and presented as a graphical “dot” representation on a map (or other user-interface screen). Tracking movement of an object within a space can be facilitated by tracking movement of a corresponding representative graphical dot in a map of the space.

In general, discretization can include one or more of: capturing sensor input (e.g., pixels, voxels, etc.), detecting objects (measurement calculation), deriving/assigning tracks (movement extraction), and presenting simpler (e.g., graphical) object representations (e.g., dots). For example, in one aspect, sensor input, such as, video, is captured and discretization collectively includes: detecting objects, deriving/assigning tracks, and present dots at a user interface. However, discretization can also include and/or be facilitated by other combinations of described activities.

General Architecture

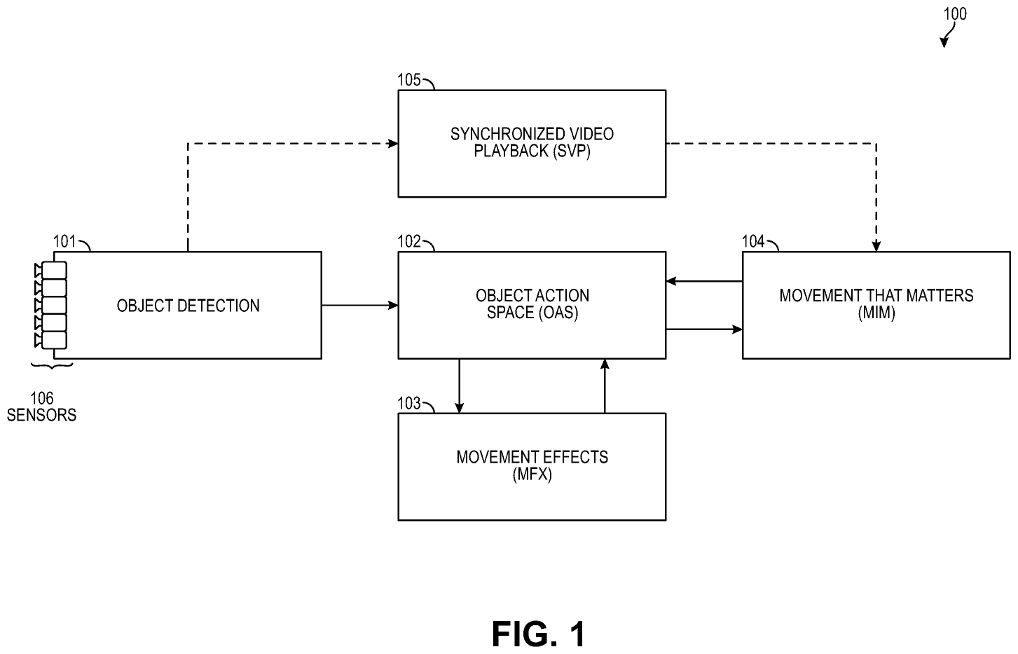

FIG. 1 depicts an example computer architecture 100 that facilitates object movement imaging. As depicted, computer architecture 100 includes object detection 101, object action space 102, movement effects 103, movement that matters 104, synchronized video playback 105, and sensors 106.

Object detection 101 can receive video frames (or other sensor input) from sensors 106 observing a space. Object detection 101 can use Machine Learning techniques to identify the objects of interest (i.e., perform object detection (OD)) in video frames (or other sensor input). Object detection 101 can also perform movement extraction (ME) determining the movement of identified objects over time and space. Object detection 101 can output a track per object in the space, in real time. In one aspect, object detection 101 discretizes identified objects (e.g., people, animals, etc.) into representative simpler graphical elements, such as, for example, dots. The representative simpler graphical elements are then tracked within a space.

Object Action Space (OAS) 102 collects tracks from across all sensors and over time and stores them in indexed databases. OAS 102 also keeps track of spatial metadata like rooms or other spaces, groups of objects, and other entities used for Alerts and Analytics.

Movement Effects (mFx) 103 performs checks for alerts and calculations for analytics. mFx 103 can implement pattern detection algorithms looking for conditions to be met. mFx 103 can operate on the tracks stored within OAS 102 that were generated by MiiM 101.

Movement that Matters (MtM) 104 can be and/or include a user interface. MtM 104 can interoperate with user applications based on finding, visualizing, and analyzing movement that matters for the user.

Synchronized Video Playback (SVP) 105 enables users to view live or Video-on-Demand (VOD) playback of video streams from video cameras installed in a space. SVP 105 can automatically synchronize video streams from multiple cameras with each other and with OAS 102 unified (and possibly live) Display (the dots on the map). Video frames can be managed and searched with a relatively high precision to provide a seamless and immersive user experience.

Movement Extraction

One or more of position, velocity, acceleration, orientation, pose, etc. can be imaged for an object. An object can be continuously tracked over time. Objects can be tracked in an Object Action Space (e.g., OAS 102) independent of sensor type.

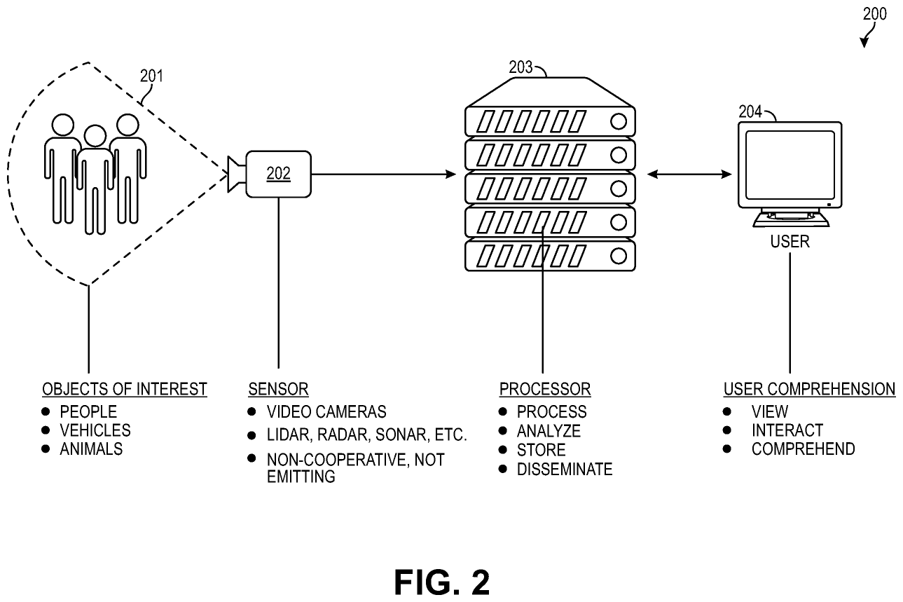

Turning to FIG. 2, FIG. 2 depicts computer architecture 200 that facilitates object movement imaging. As depicted, computer architecture 200 includes objects of interest 201, sensor 202, processor 203, and user interface 204.

Sensor 202 can scan objects of interest 201 (in a space). Sensor 202 can include any of a video camera, lidar, sonar, radar, etc. Objects of interest 201 can include people, vehicles, animals, etc. Processor 203 can process, analyze, store, and disseminate movement associated with objects of interest 201. In one aspect, processor 203 disseminates movement information to a user. Disseminating movement information can include presenting discretized representations of objects (e.g., dots) at user interface 204. The user can view, interact, and comprehend object movement (e.g., movement of representative dots on a map) through user interface 204.

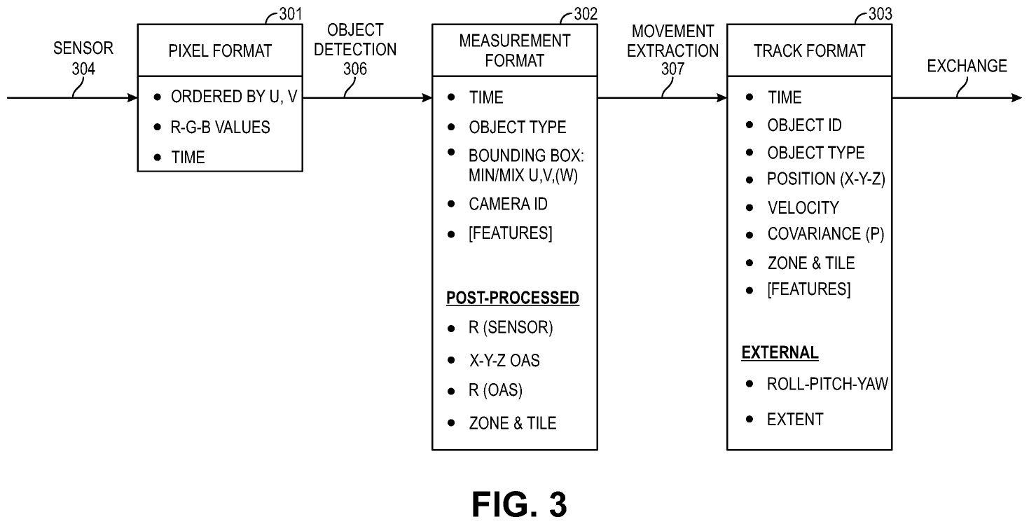

Turning to FIG. 3, FIG. 3 depicts example pixel format 301, measurement format 302, and track format 303. In general, sensor 304 (e.g., sensor 106, sensor 202, etc.) can sense pixels of pixel format 301. Object detection 306 (e.g., object detection 101, processor 203, etc.) can derive measurements in measurement format 302 from pixels in pixel format 301. Movement extraction 307 (e.g., object detection 101, processor 203, etc.) can derive tracks in track format 303 from measurements in measurement format 302. Tracks in track format 303 can be passed to an exchange (e.g., exchange 507) for analytics. Detected objects can be discretized into simpler graphical representations (e.g., dots). Tracks can be of the simpler graphical representations.

In general, object detection can include detecting objects from a plurality of pixels. Object detection can include detecting features, such as, for example, corners, edges, etc. within the plurality of pixels. Objects (e.g., people) can be detected from a group of detected features.

Sensors can operate in a centralized and/or distributed environment.

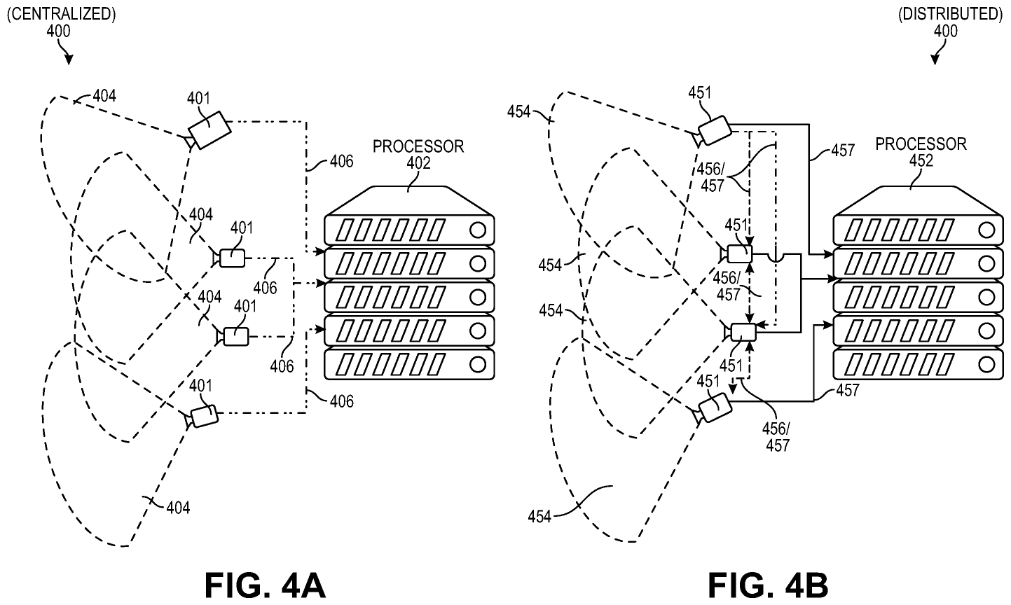

FIG. 4A depicts an example centralized sensor arrangement 400. As depicted, centralized sensor arrangement 400 includes sensors 401 and processor 402. Each of sensors 401 has a corresponding Field of View (FoV) 404 covering at least part of a common space (and potentially overlapping with coverage of other of sensors 401). Sensors 401 can sense pixels (e.g., in pixel format 301). Sensors 401 can perform object detection internally and derive measurements 406 (e.g., in measurement format 302) from the sensed pixels. Sensors 401 can send measurements 406 (single arrowed lines) to processor 402.

Processor 402 can perform movement extraction deriving tracks (e.g., in track format 303) from measurements 406. Processor 402 can also process, analyze, store, and disseminate derived tracks.

Since Fields of View (FoV) 404 vary, an object may be detected within different Fields of View (FOV) 404 at different times (e.g., an earlier time and a later time). Processor 402 can correlate measurements at later times with tracks derived from measurements at earlier times.

FIG. 4B depicts an example distributed sensor arrangement 450. As depicted, centralized sensor arrangement 450 includes sensors 451 and processor 452. Each of sensors 451 has a corresponding Field of View (FoV) 454 covering at least part of a common space (and potentially overlapping with coverage of other of sensors 451). Sensors 451 can sense pixels (e.g., in pixel format 301). Sensors 451 can perform object detection internally and derive measurements 456 (e.g., in measurement format 302) from the sensed pixels. Sensors 451 can also perform movement extraction deriving tracks 457 tracks (e.g., in track format 303) from measurements 456.

Sensors 451 can exchange measurements 456 and/or tracks 457 with one another (double arrowed lines). Sensors 451 can also send tracks 457 to processor 452 (single arrowed lines). Processor 452 can also process, analyze, store, and disseminate derived tracks.

Since Fields of View (FoV) 454 vary, an object may be detected within different Fields of View (FOV) 404 at different times (e.g., an earlier time and a later time). Cameras 451 and/or processor 452 can correlate measurements at later times with tracks derived from measurements at earlier times.

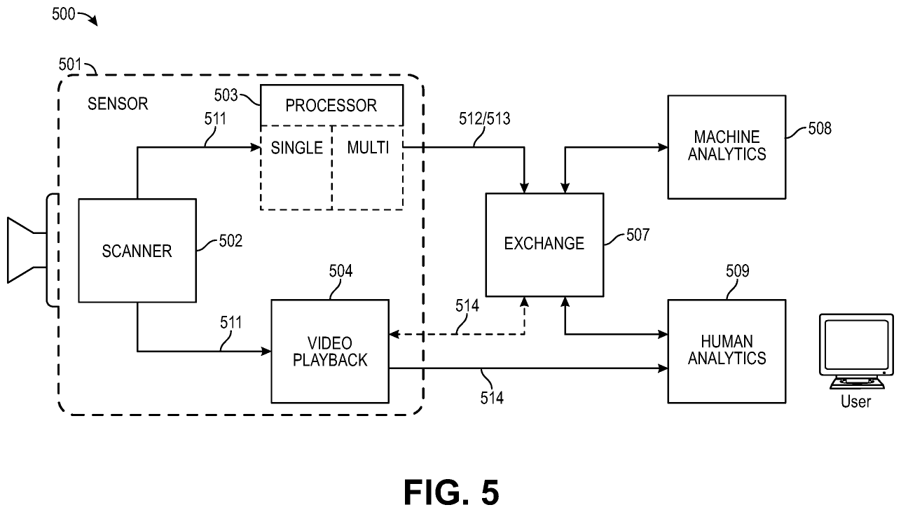

FIG. 5 depicts an example computer architecture 500 that facilitates object movement imaging. As depicted, computer architecture includes sensor 501, exchange 507, machine analytics, and human analytics 509. Sensor 501 further includes scanner 502, processor 503, and video playback 504. Scanner 502 can capture pixels 511 from within a Field of View (FOV). Scanner 502 can send pixels 511 to processor 503 and/or to video playback 504. Processor 503 can derive measurements 512 and/or tracks 513 from pixels 511 (including discretizing objects). Processor 503 can derive measurements 512 and/or tracks 513 for a single object or for multiple objects. Processor 503 can send measurements 512 and/or tracks 513 to exchange 507. Video playback 504 can playback video 514 from pixels 511. Video playback 504 can also send video 514 to exchange 507 and/or to human analytics 509.

Exchange 507 can share any of measurements 512, tracks 513, or video 514 with machine analytics 508 and/or human analytics 509. A user can create, modify, change, delete, etc. human analytics 509. In one aspect, a human in the loop can review, amend, modify, change, delete, etc., information about any measurements 512 and/or tracks 514 on exchange 507.

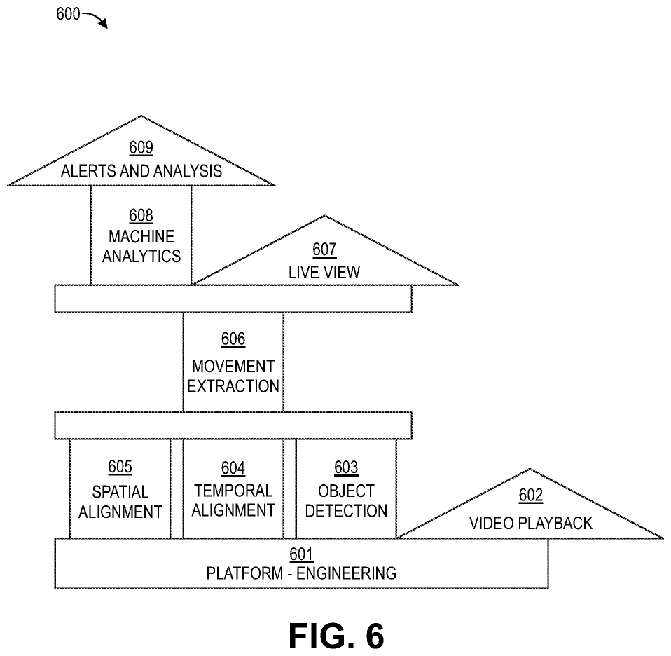

FIG. 6 depicts an example logical hierarchy 600 of movement imaging components. An engineering platform 601 provides a foundation for video playback 602, object detection 603, temporal alignment 604, and spatial alignment 605. Movement extraction 606 can be realized from object detection 603, temporal alignment 604, and spatial alignment 605. Live (and unified) view 607 and machine analytics 608 can be built on movement extraction 606. Alerts and analysis 609 can then be built on machine analytics 608. In one aspect, movement extraction 606 and/or live (and unified) view 607 discretizes detected objects into simpler graphical representations, such as, for example, dots. Live (and unified) view 607 can then depict one or more simpler graphical representations (e.g., dots) moving wherein each dot simpler graphical representation represents a detected object.

Video playback 602, live (and unified) view 607, and alerts and analysis 609 represent generally “what” is happening. Video playback 602 is built on platform 601. Platform 601 can include a scanner, a set of one or more sensors working together to cover a space along with corresponding communication and processing to gather scanner data, process the scanner data, and disseminate the scanner data to a user.

Live (and unified) view 607 is built on movement extraction (ME), which in turn utilizes object detection 603, temporal alignment 604, and spatial alignment 605. Alerts and analysis 609 can utilize machine analytics 608 that is based (at least in part) on outputs from movement extraction 606. Human analytics can be performed using live (and unified) view 607.

In general, movement extraction (ME) within a machine can include receiving measurements as input from 1-N sensors and detecting objects over time. One track per (e.g., discretized) object can be output over time. Sensors can include a lens and a processor. The processor can produce tracks for an assigned zone. As an object moves in an Object Action Space (e.g., 102) (e.g., represented by a simpler graphical representation, such as, a dot), a corresponding track can be handed off from one zone to another zone.

Movement extraction (ME) can continuously produce one track per object (human, vehicle, animal etc.) while minimizing leakage and false alarms. In one aspect, movement extraction updates at 10 Hz, with <200 msec latency, <50 cm positional error, and 50 cm/sec velocity error. Movement extraction can operate in both indoor and outdoor environments, and in all weather conditions, for any number of objects across any number of sensors (of an Object Action Space, for example, 102).

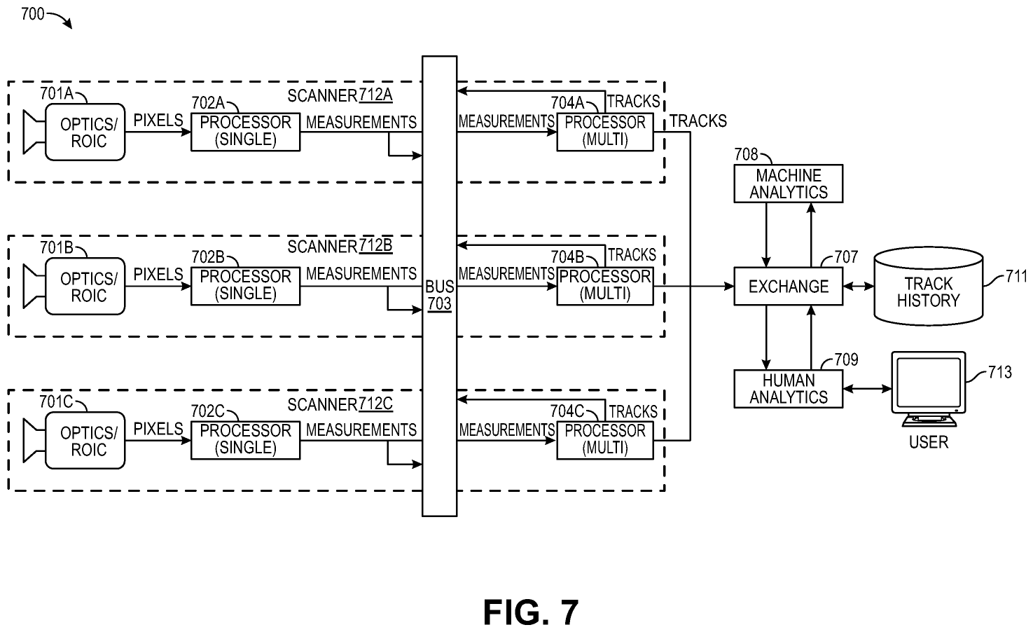

FIG. 7 depicts an example computer architecture 700 that facilitates movement extraction. As depicted, computer architecture 700 includes scanners 712A, 712B, and 712C, exchange 707, machine analytics 708, human analytics 709, track history 711, and user 713. Scanner 712A further includes sensor 701A, processor 702A, and processor 704A. Scanner 712B further includes sensor 701B, processor 702B, and processor 704B. Scanner 712C further includes sensor 701C, processor 702C, and processor 704C. Bus 703 interconnects scanners 712A, 712B, and 712C.

Sensors 701A, 701B, and 701C can capture pixels from within corresponding (and potentially overlapping) Fields of View (FOV) of a space. Sensors 701A, 701B, and 701C can send captured pixels to processors 702A, 702B, and 702C respectively. Processors 702A, 702B, and 702C can derive corresponding measurements from captured pixels. Each of processors 702A, 702B, and 702C can forward corresponding measurements to processors 704A, 704B, and 704C respectively as well as put the corresponding measurements onto bus 703 for distribution to other of processors 704A, 704B, and 704C.

Processors 704A, 704B, and 704C can generate corresponding tracks from the measurements. Each of processors 704A, 704B, and 704C can forward corresponding tracks to exchange 707 as well as put the corresponding tracks onto bus 703 for distribution to other of processors 704A, 704B, and 704C. Exchange 707 can maintain track history 711. Machine analytics 708 and human analytics 709 can interact with tracks through exchange 707.

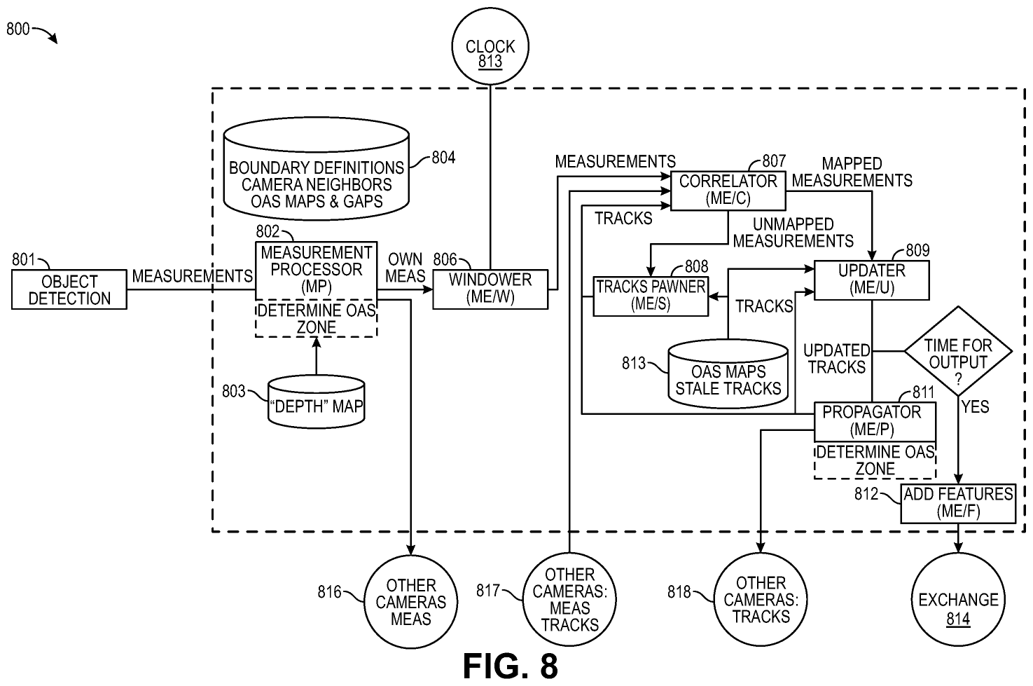

FIG. 8 depicts computer architecture 800 that facilitates movement extraction. As depicted, computer architecture includes object detection 801, measurement processor 802, depth map 803, maps and gaps 804, windower 806, correlator 807, track spawner 808, updater 809, propagator 811, add features 812, clock 813, and exchange 814. Measurements from object detection 801 can be sent to measurement processor (MP) 802. MP 802 can process measurements in accordance with a depth map 803 and boundary definitions, camera (and/or other sensors) neighbors, OAS maps 804, etc. Processed measurements can be sent to other cameras 816 (and/or other sensors) as well as to a clocked windower 806 (clocked by clock 813). Clocked windower 806 can send processed measurements to correlator 807. Correlator 807 can receive tracks from other cameras 817 (and/or other sensors) as well as tracks from track spawner 808 and/or propagator 811.

Correlator 807 can attempt to map measurements to existing tracks. Mapped measurements can be sent to updater 809. Unmapped measurements can be sent to track spawner 808. Object action space (OAS) 813 can map stale tracks. Updater 809 can send updated tracks to propagator 811 and/or to add features 812 and onto an exchange at appropriate times. Propagator 811 can send tracks to other cameras 818 (and/or other sensors) as well as to correlator 807 or back to updater 809.

As described, movement extraction can be implemented at measurement processor 802. Measurement processor 802 can calculate object bounding box size, set up an R matrix (camera via), project an object centroid into an OAS frame, project the R matrix into the OAS frame, get a zone, and get a tile.

Inputs into measurement processor 802 can include object detections (e.g., centroid, bounding box, source camera (and/or other sensor) ID, and object type), camera (and/or other sensor) parameters (e.g., extrinsic parameters, such as, position and orientation), intrinsic matrix, zone and tile definitions, for example, polygons). Measurement processor 802 can output updated measurements (e.g., measurement format 302), including size, R matrix (camera and world), centroid projected onto world frame, zone, and tile. These can run out of sequence, one measurement at a time, or in parallel.

R can represent a sensor noise covariance, that is, the expected amount of noise in each dimension for the sensor. In one aspect, R is essentially a Kalman filter indicating how to weight the new measurements with respect to the state (the track). R can be determined for the camera frame and also projected into an OAS frame. R can be a function of the size of the detected object. In some aspects, uncertainty of the sensor point angles and range can be also be considered.

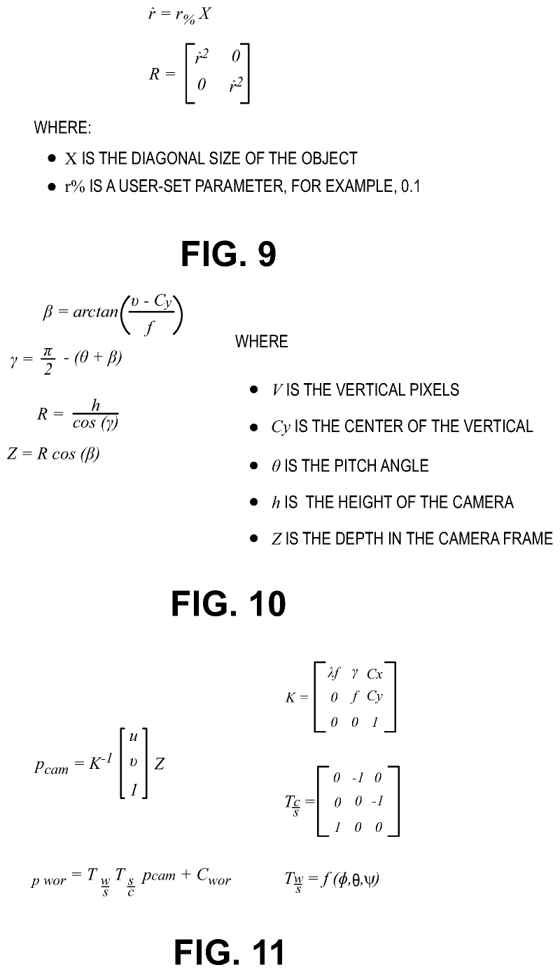

FIG. 9 depicts example equations for calculating sensor noise covariance (R).

Different frames of reference including solar system (point of Aries), Earth (ECI, ECEF, etc.), local vertical—local horizontal (LVLH), body, etc. can be considered. Right handed orthonormal frames can be used (cross product of any two gives the third). Frames of reference can define 3 orthonormal axes, point of origin, rotations (e.g., quaternions, Rodriquez parameters, Euler angles, represent as DCM, or transformation matrix). In some aspects, it can be assumed that objects are located on the ground.

Within a frame of reference, object height can be determined.

FIG. 10 depicts example equations for calculating object height.

FIG. 11 depicts example equations for calculating height of a single point.

When calculating the height of a volume, four bounding box coordinates can be transferred into OAS. Range and angle from each point to camera (and/or other sensors) can be calculated. Shortest range is closest to bottom. Midpoint corners is middle, which can be made an anchor. In one aspect, an assumption that the object is a shoebox of known extent (X, Y, Z) is considered. A backoff that is the diagonal of X and Y extent can be calculated and the centroid raised by Z extent.

In some aspects, various other assumptions can be considered. For example, the size of tracked objects may be known, that the base of objects can be seen, that a depth map (or height) is what the base on an object it touching. An error budget is the accumulation of each divergence from these assumptions.

In other aspects, sensors, such as, stereoscopic cameras, Lidar, radar, sonar, etc., having improved three-dimensional (3D) quality can be used, reducing the consideration of various described assumptions. In further aspects, deep learning approaches can be utilized to determine distance, for example, instead of stereo, lidar, radar, sonar, etc.

Accordingly, measurement processing can occur at (or near) the end of object detection. Measurement processing can calculate R, assign zones and tiles, and do world projection. World projection can include going from 2D to 3D.

Referring back to FIG. 8, correlator 807 can correlate measurements and tracks. Inputs to correlator 807 can include measurements for a zone, from a current lens and other lenses in a zone, and tracks for a zone and other neighboring zones. Outputs from correlator 807 can include measurements mapped to tracks in a zone, measurements mapped to informational tracks, and unmapped measurements.

For each time interval, correlator 807 can get all tracks for a zone and for each camera (and/or other sensor): (a) get measurements from the camera (and/or other sensor), (b) calculate distance between each measurement and each track, (c) pregate, (d) assign, (e) postgate, and (f) update measurement with Track ID. Correlator 807 can correlate tracks for multiple targets across multiple sensors. Correlator 807 can also correlate later received measurements (e.g., at ti) associated with an object with a track derived from earlier received measurements (e.g., at ti) associated with the object (and possibly from a different sensor).

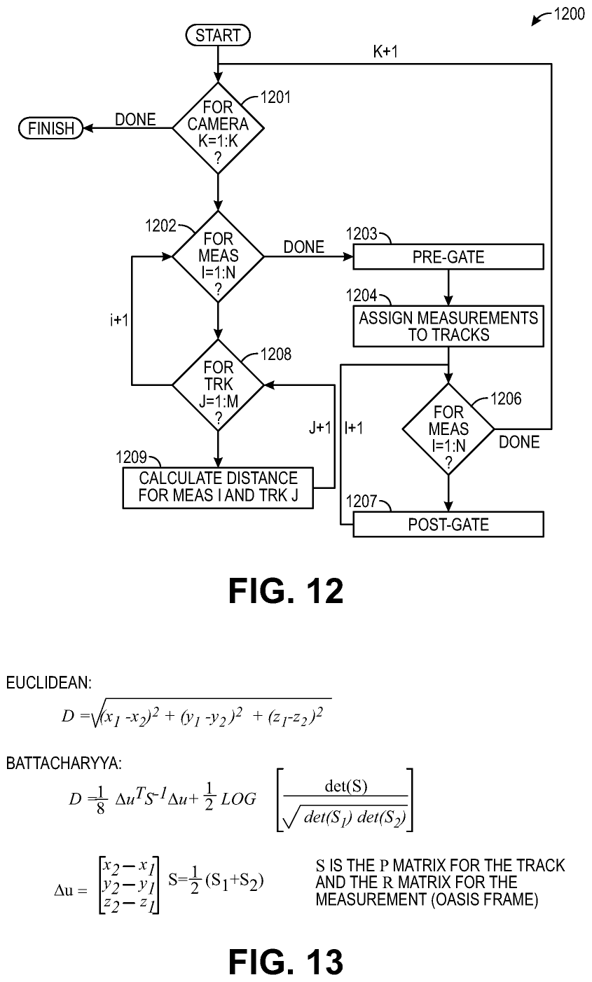

FIG. 12 depicts an example track correlation flow 1200. Correlator 807 can implement track correlation flow 1200.

Referring to FIG. 12, for each camera (at 1201), the distance between each measurement (at 1202) and existing tracks (at 1208) can be calculated until all measurements for the camera are processed. At 1209 distances between a measurement and track can be calculated. Distance calculations can be used to correlate tracks and measurements. Generally, the closer a track and a measurement are to one another, the more likely they belong together. Spatial distance can be used to uniquely identify objects. For example, there may be multiple red cars but only one red car at specific coordinates. Distance calculations can include Euclidean 2-norm, Bhattacharyya, 2D vs. 3D, etc. Referring briefly to FIG. 13, FIG. 13 depicts example equations for distance calculations.

Referring back to FIG. 12, when all distances for all measurements for a camera have been processed (done at 1202), measures can be pre-gated 1203. Pre-gate 1203 can include removing any measurements from an assigner that are too far away from (potentially all) tracks. Far measurements can be marked as “unmapped”. A pre-gate can be tuned on different distance functions.

An assigner can assign a measurement to a closest track 1204 based on a distance matrix. The assigner can implement a Hungarian algorithm or other heuristic based algorithms. The assigner can make the maximum assignments possible, limited by number of tracks or measurements. The assigner can be configured to assign one measurement to one track (e.g., exactly).

For each measurement (1206), post-gate 1207 can include another pass through (potentially all) assignments. If a measurement is assigned to a track that is too far away, post-gate 1207 can break the assignment. Breaking an assignment can be based on any distance or desired threshold. When an assignment is broken, the measurement can be marked as “unmapped”. Neural networks can be used to estimate distances.

Accordingly, correlation (e.g., as implemented at correlator 807) can be used to bring measurements and tracks together.

Add features 812 can implement featured added correlation. For example, aspects can utilize “distance” in what an object looks like (e.g., a feature or signature of the object). Features can be derived from the measurement process, for example, inherited by track. A track can have features of most recent measurement and may have a different feature vector per camera (and/or other sensor). Aspects of the invention can take measurements to address deriving different features from different camera (and/or other sensor) views, such as, angles, lighting, distance, background, obscuration, etc. Feature distance can be cosine of 2 N-dimensional vectors, weighted and then combined with location distance. For example, feature distance can be calculated as:

$$cos θ = \frac{{x}^{T} \cdot y}{\vert x \vert \vert y \vert}$$

Color can be considered as an R-G-B per pixel distribution over an object. Background pixels within a bounding box can be masked out. Color can be considered as a mean value (3 mean R-G-B values), as a mean value+standard deviation (6 values), as 10 bins (30 values), etc.

Aspects of the invention can use mechanisms, such as YOLO, ResNet, or CenterNet to identify individual objects in a scene, including within a crowd.

Object detections are projected into 3D world space, with each object individually projected. A simplified “shoebox” can be used to estimate the projection of the centroid in 3D world space from the 2D image. Projected centroids can be fed into a multi-sensor (e.g., camera, lidar, radar, etc.), multi-target correlator, which then feeds object detections from multiple sensors (e.g., cameras, lidar, radar, etc.) into a Kalman filter (or equivalent). The filter provides tracks of individual objects with increased accuracy, in every frame and over time as well.

Aspects of the invention can detect crowds, count individuals, and estimate density from looking at a set of tracks (through discretized dot representations). Tracking individual objects over time and space, provides relatively more information (increased fidelity) for analysis and alerting than simply crowd size and density.

Aspects of the invention include projecting zone into a world view, and can be based on overlapping fields of view of multiple sensors (e.g., cameras). Tiles can be based on either a uniform rectangular pattern over the field of view, or rectangles sized based on object density, but not necessarily on contextual scenarios (like “near the cash register,” or “near the display,” etc.).

Accordingly, aspects of the invention improve comprehension of object movement using scanning technologies that do not rely on a cooperative tag on the objects being tracked (such as RFIDs or cell signals).

Sensor Architectures

Various different sensor (e.g., camera) architectures can be utilized to implement described aspects of the invention. For example, sensor coverage can be facilitated via a single sensor, multiple coupled sensors sharing tracks, multiple sensors sharing measurements, etc. as well as combinations thereof. Sensors that share tracks may be referred to as “loosely” coupled sensors. Sensors that share measurements may be referred to as “tightly” coupled sensors. Sensors sharing measurements can fuse the measurements into tracks. Tightly coupled sensors can be combined in a centralized arrangement or mesh arrangement.

In one aspect, the terms “loosely coupled” and “tightly coupled” are borrowed from the Guidance, Navigation, and Control (GNC) community. GNC is a branch of engineering dealing with the design of systems to control the movement of vehicles, especially, automobiles, ships, aircraft, and spacecraft.

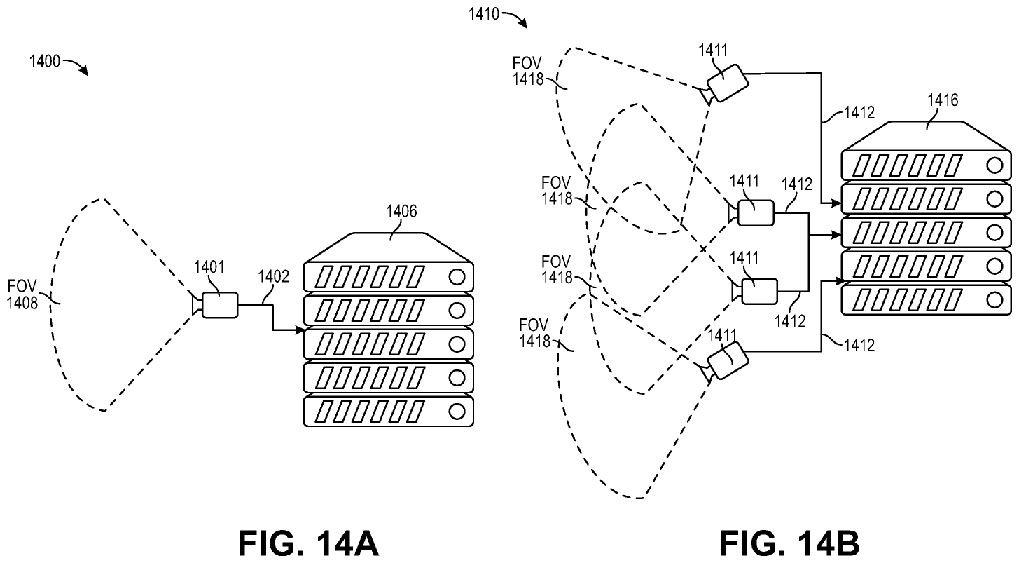

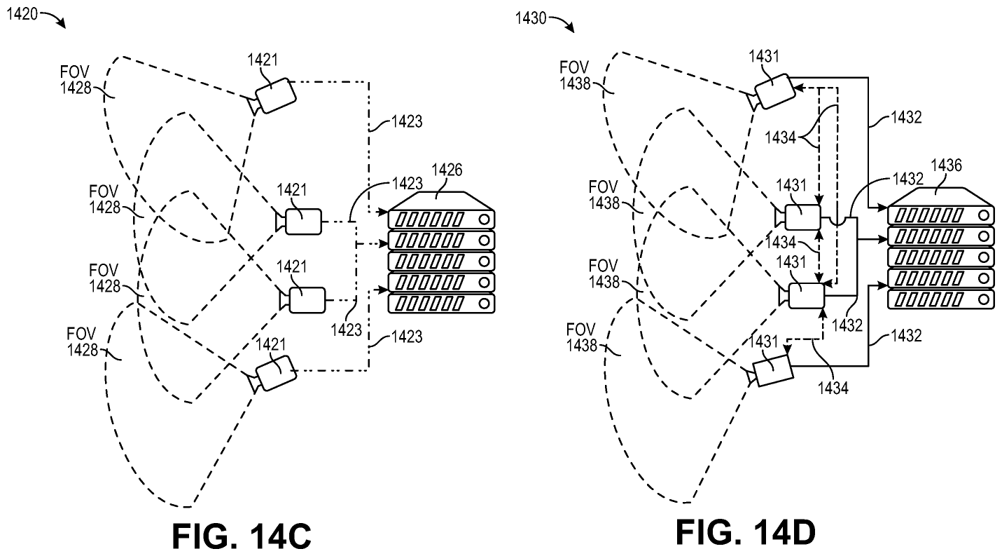

FIG. 14A depicts an example single camera architecture 1400. As depicted, architecture 1400 includes camera 1401 and processor 1406. Camera 1401 has field of view 1408. For each object within field of view 1408, camera 1401 derives a track 1402 locally. Per object, camera 1401 sends a track 1402 to processor 1406. Processor 1406 can disseminate received tracks, for example, to an exchange.

FIG. 14B depicts an example loosely coupled multi-camera architecture 1410. As depicted, architecture 1410 includes cameras 1411 and processor 1416. Cameras 1411 have corresponding fields of view 1418 (some of which at least partially overlap with one another). For each object within fields of view 1418, cameras 1411 derive a track 1412 locally. Per object, cameras 1411 send tracks 1412 to processor 1416. Processor 1416 can disseminate received tracks, for example, to an exchange.

FIG. 14C depicts an example tightly coupled multi-camera centralized architecture 1420. As depicted, architecture 1420 includes cameras 1421 and processor 1426. Cameras 1421 have corresponding fields of view 1428 (some of which at least partially overlap with one another). For each object within fields of view 1428, cameras 1421 derive a measurement 1423 locally. Per object, cameras 1421 send measurements 1423 to processor 1426. Processor 1426 can then derive tracks from the measurements. Processor 1426 can disseminate derived tracks, for example, to an exchange.

FIG. 14D depicts an example tightly coupled multi-camera mesh architecture 1430. As depicted, architecture 1430 includes cameras 1431 and processor 1436. Cameras 1431 have corresponding fields of view 1438 (some of which at least partially overlap with one another). For each object within fields of view 1438, cameras 1431 derive tracks and measurements 1434 locally. Cameras 1431 can exchange derived tracks and measurements 1434 among one another. Per object and from tracks and measurements 1434 (as well as locally derived measurements), cameras 1431 can further derive tracks 1432. Per object, cameras 1431 send tracks 1432 to processor 1436. Processor 1426 can disseminate derived tracks, for example, to an exchange.

Loosely Coupled Architecture

In a loosely coupled architecture tracking (i.e., track derivation) can be implemented at the sensor (e.g., camera). When there are multiple sensors (e.g., cameras), tracks received from cameras are fused at an exchange and/or machine analytics at a specified rate. For example, loose coupler 1508 can fuse tracks from different sensors.

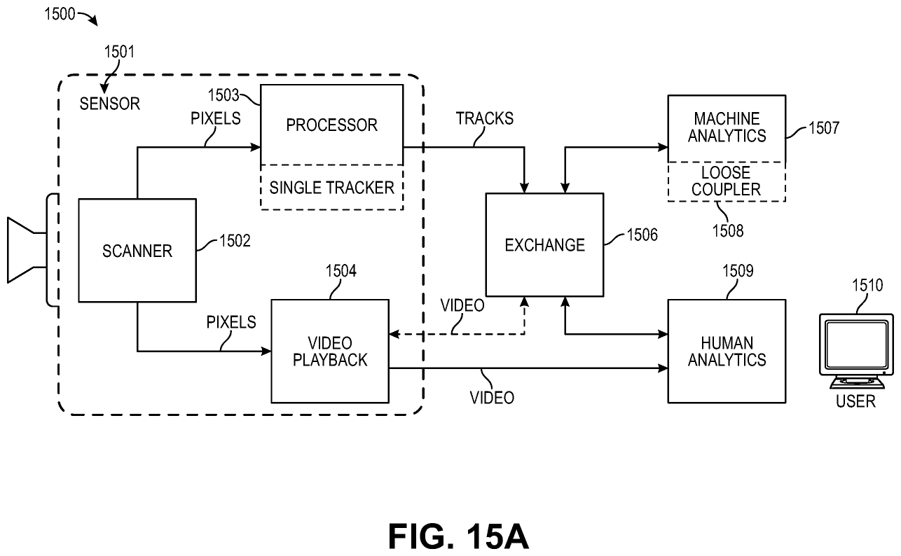

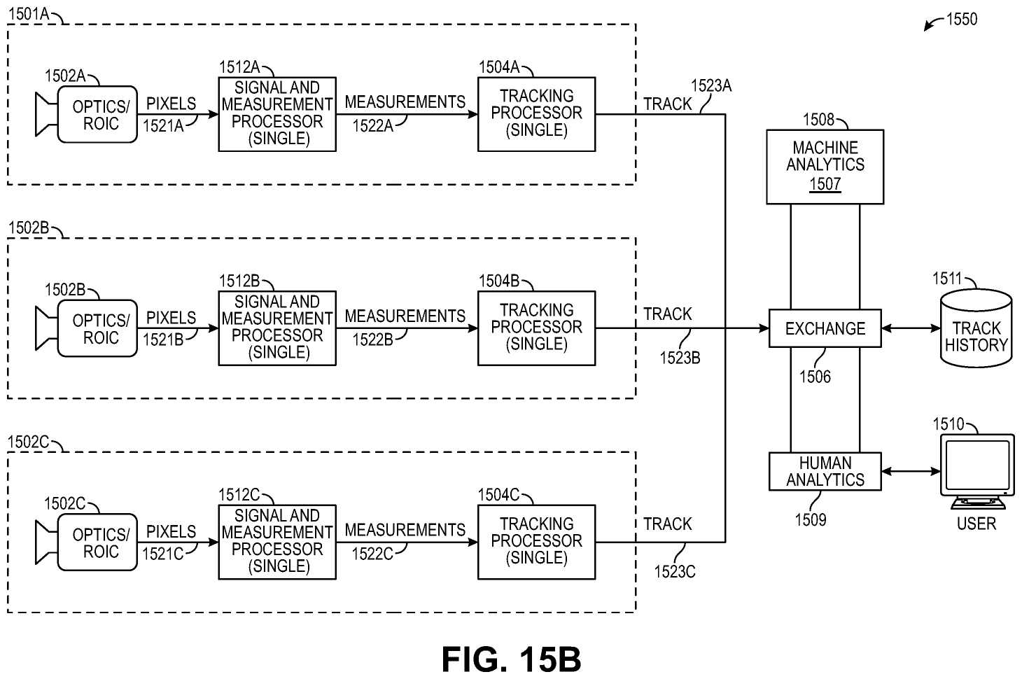

FIG. 15A depicts a loosely coupled architecture 1500. Loosely coupled architecture 1500 can correspond to architectures 1400 and/or 1410. A single sensor architecture can be considered a loosely coupled system where the number of sensors is one.

As depicted, architecture 1500 includes sensor 1501, exchange 1506, machine analytics 1507, human analytics 1509, and user 1510. Sensor 1501 further incudes scanner 1502, processor 1503, and video playback 1505. Processor 1503 further includes single tracker 1504. Processor 1503 can implement single tracker 1504 to derive a single track per object within sensor 1501's field of view. Machine analytics 507 further includes loose coupler 1508.

Scanner 1502 can send scan data (e.g., pixels of a video stream) to processor 1503 and video playback 1505. Processor 1503 can derive measurements from the pixels. Single tracker 1504 can in turn derive tracks from the measurements. Video playback 1505 can play the video stream. Processor 1503 can send derived tracks to exchange 1506. Video playback 1505 can send video to exchange 1506 and/or to human analytics 1509. Exchange 1506 can share tracks or video with machine analytics 1507 and/or human analytics 1509. In one aspect, loose coupler 1508 fuses tracks received from exchange 1506. User 1510 can create, modify, change, delete, etc. human analytics 1509.

FIG. 15B depicts a loosely coupled architecture 1550. Loosely coupled architecture 1550 can correspond to architectures 1400 and/or 1410.

As depicted, architecture 1550 includes sensors 1501A, 1501B, and 1501C (e.g., similar to cameras 1411 and/or sensor 1501), exchange 1506, machine analytics 1507, human analytics 1509, user 1510, and track history 1511. Sensor 1501A further includes scanner 1502A, signal and measurement processor (single) 1512A, and tracking processor (single) 1504A. Sensor 1501B further includes scanner 1502B, signal and measurement processor (single) 1512B, and tracking processor (single) 1504B. Sensor 1501C further includes scanner 1502C, signal and measurement processor (single) 1512C, and tracking processor (single) 1504C. Machine analytics further includes loose coupler 1508.

Within sensor 1501A, scanner 1502A can send pixels 1521A to signal and measurement processor 1512A. Signal and measurement processor 1512A can derive corresponding measurements 1522A from pixels 1521A. Signal and measurement processor 1512A can send measurements 1522A to tracking processor 1504A. Tracking processor 1504A can derive track 1523A from measurements 1522A. Tracking processor 1504A can send track 1523A to exchange 1506. In one aspect, signal and measurement processor 1512A and tracking processor 1504A are implemented at processor 1503 (of architecture 1500) or another similar processor.

Within sensor 1501B, scanner 1502B can send pixels 1521B to signal and measurement processor 1512B. Signal and measurement processor 1512B can derive corresponding measurements 1522B from pixels 1521B. Signal and measurement processor 1512B can send measurements 1522B to tracking processor 1504B. Tracking processor 1504B can derive track 1523B from measurements 1522B. Tracking processor 1504B can send track 1523B to exchange 1506. In one aspect, signal and measurement processor 1512B and tracking processor 1504B are implemented at processor 1503 (of architecture 1500) or another similar processor.

Within sensor 1501C, scanner 1502C can send pixels 1521C to signal and measurement processor 1512C. Signal and measurement processor 1512C can derive corresponding measurements 1522C from pixels 1521C. Signal and measurement processor 1512C can send measurements 1522C to tracking processor 1504C. Tracking processor 1504C can derive track 1523C from measurements 1522C. Tracking processor 1504C can send track 1523C to exchange 1506. In one aspect, signal and measurement processor 1512C and tracking processor 150CB are implemented at processor 1503 (of architecture 1500) or another similar processor.

Exchange 1506 can maintain track history 1511. Machine analytics 1507 and human analytics 1509 (potentially via user 1510) can interact with tracks 1523 through exchange 1506. Machine analytics 1507 (e.g., using loose coupler 1508) can appropriately fuse tracks 1523A, 1523B, and 1523C.

Tightly Coupled Centralized Architecture

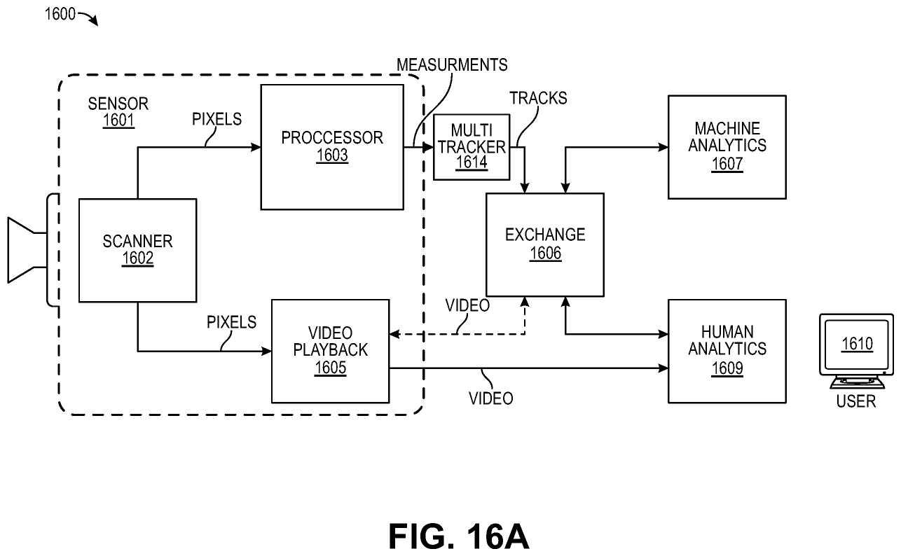

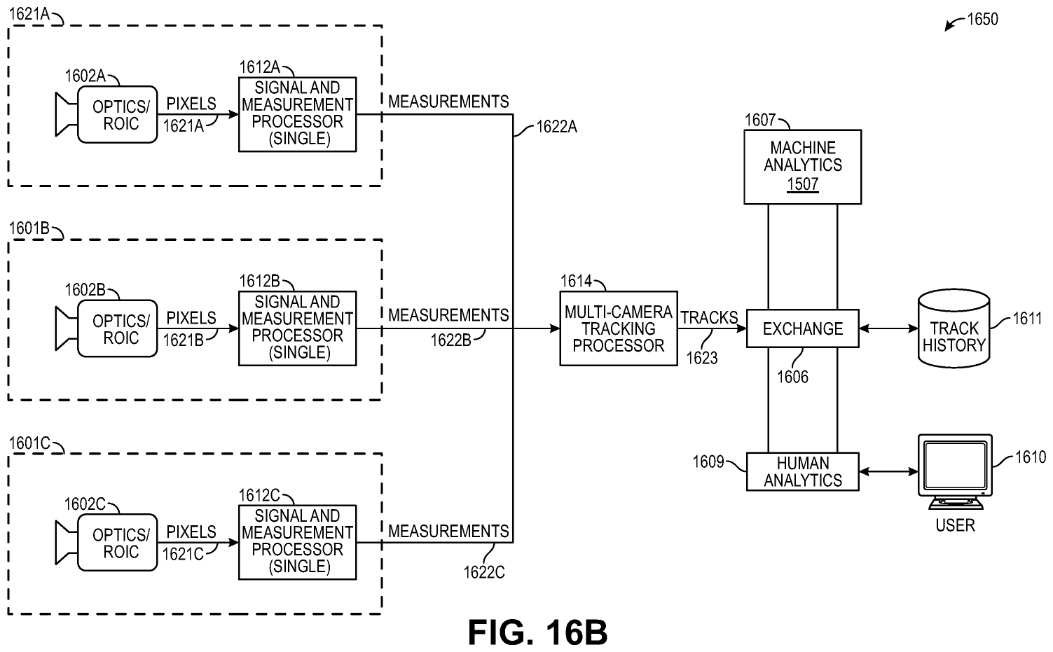

FIG. 16A depicts a tightly coupled centralized architecture 1600. Architecture 1600 may correspond to architecture 1420.

As depicted, architecture 1600 includes sensor 1601, exchange 1606, machine analytics 1607, human analytics 1609, user 1610, and multitracker 1614. Sensor 1601 further includes scanner 1602 (e.g., for capturing pixels), processor 1603, and video playback 1605 for playing back video. Processor 1603 can include components configured to derive measurements per object within sensor 1601's field of view.

Scanner 1602 can send scan data (e.g., pixels of a video stream) to processor 1603 and video playback 1605. Processor 1603 can derive measurements from the pixels. Processor 1603 can send derived measurements to mutli-tracker 1614. Multi tracker 1614 can derive tracks from the measurements. Mutli-tracker 1614 can send derived tracks to exchange 1606. Video playback 1605 can send video to exchange 1606 and/or to human analytics 1609. Exchange 1606 can share tracks or video with machine analytics 1607 and/or human analytics 1609. User 1610 can create, modify, change, delete, etc. human analytics 1609.

FIG. 16B depicts a tightly coupled centralized architecture 1650. Architecture 1650 may correspond to architecture 1420.

As depicted, architecture 1650 includes sensors 1601A, 1601B, and 1601C (e.g., similar to cameras 1421 and/or sensor 1601), exchange 1606, machine analytics 1607, human analytics 1609, user 1610, track history 1611, and multi-camera tracking processor 1614. Sensor 1601A further includes scanner 1602A and signal and measurement processor (single) 1612A. Sensor 1601B further includes scanner 1602B and signal and measurement processor (single) 1612B. Sensor 1601C further includes scanner 1602C and signal and measurement processor (single) 1512C.

In general, multi-camera tracking processor 1614 can derive tracks from measurements received from different sensors.

Within sensor 1601A, scanner 1602A can send pixels 1621A to signal and measurement processor 1612A. Signal and measurement processor 1612A can derive corresponding measurements 1622A from pixels 1621A. Signal and measurement processor 1612A can send measurements 1622A to multi-camera tracking processor 1614. Multi-camera tracking processor 1614 can derive a track 1623 from measurements 1622A. Multi-camera tracking processor 1614 can send the track 1623 to exchange 1606. In one aspect, signal and measurement processor 1612A is implemented at processor 1603 (of architecture 1600) or another similar processor.

Within sensor 1601B, scanner 1602B can send pixels 1621B to signal and measurement processor 1612B. Signal and measurement processor 1612B can derive corresponding measurements 1622B from pixels 1621B. Signal and measurement processor 1612B can send measurements 1622B to multi-camera tracking processor 1614. Multi-camera tracking processor 1614 can derive a track 1623 from measurements 1622B. Multi-camera tracking processor 1614 can send the track 1623 to exchange 1606. In one aspect, signal and measurement processor 1612B is implemented at processor 1603 (of architecture 1600) or another similar processor.

Within sensor 1601C, scanner 1602C can send pixels 1621C to signal and measurement processor 1612C. Signal and measurement processor 1612C can derive corresponding measurements 1622C from pixels 1621C. Signal and measurement processor 1612C can send measurements 1622C to multi-camera tracking processor 1614. Multi-camera tracking processor 1614 can derive a track 1623 from measurements 1622C. Multi-camera tracking processor 1614 can send the track 1623 to exchange 1606. In one aspect, signal and measurement processor 1612C is implemented at processor 1603 (of architecture 1600) or another similar processor.

Exchange 1606 can maintain track history 1611. Machine analytics 1607 and human analytics 1609 (potentially via user 1610) can interact with tracks 1623 through exchange 1611.

Tightly Coupled Mesh Architecture

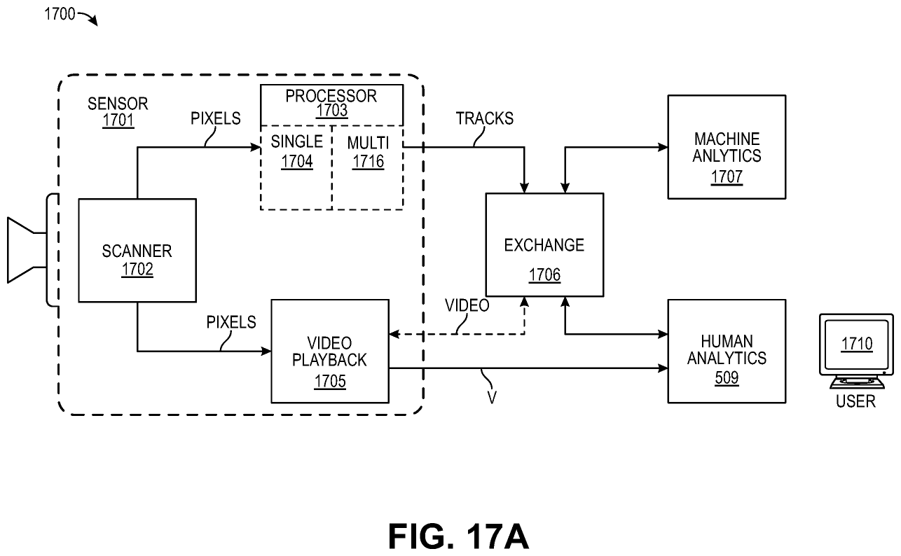

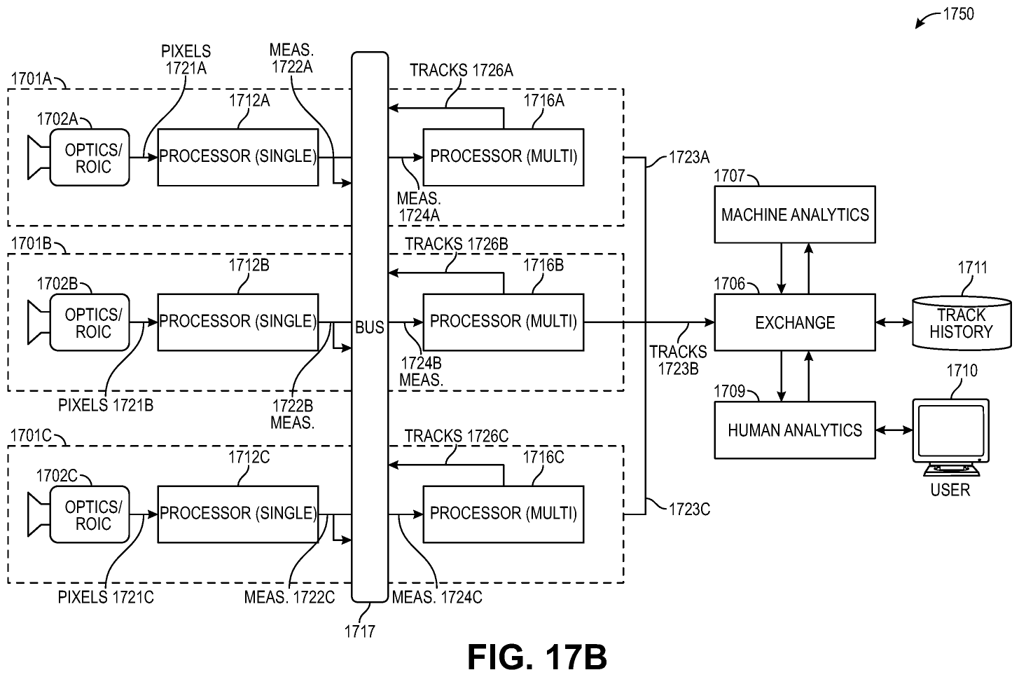

FIG. 17A depicts an additional example of a tightly coupled mesh architecture 1700. Architecture 1700 may correspond to architecture 1430.

As depicted, architecture 1700 includes sensor 1701, exchange 1706, machine analytics 1707, human analytics 1709, and user 1710. Sensor 1701 further includes scanner 1702 (e.g., for capturing pixels), processor 1703, and video playback 1705 for playing back video. Processor 1703 further includes single tracker 1704 and multitracker 1716. Processor 1703 implements single tracker 1704 to derive a single track per object within sensor 1701's field of view. Processor 1703 implements multi-tracker 1716 to derive tracks from measurements associated with and/or received from different sensors (e.g., other than sensor 1701).

Scanner 1702 can send scan data (e.g., pixels of a video stream) to processor 1703 and video playback 1705. Processor 1703 can derive measurements from the pixels. Single tracker 1704 can in turn derive tracks from the measurements. Mutli-tracker 1716 can receive measurements and/or tracks from and/or associated with other sensors. Mutli-tracker 1716 can derive other tracks from the received measurements and/or tracks. Processor 1703 can send derived tracks to exchange 1706. Video playback 1705 can play the video stream. Video playback 1705 can send video to exchange 1706 and/or to human analytics 1709. Exchange 1706 can share tracks or video with machine analytics 1707 and/or human analytics 1709. User 1710 can create, modify, change, delete, etc. human analytics 1709.

FIG. 17B depicts a tightly coupled mesh architecture 1750. Architecture 1750 may correspond to architecture 1430.

As depicted, architecture 1750 includes sensors 1701A, 1701B, and 1701C (similar to cameras 1431 and/or sensor 1701), exchange 1706, machine analytics 1707, human analytics 1709, user 1710, track history 1711, and bus 1717. Sensor 1701A further includes scanner 1702A, processor (single) 1712A and processor (multi) 1716A. Sensor 1701B further includes scanner 1702B, processor (single) 1712B and processor (multi) 1716B. Sensor 1701C further includes scanner 1702C, processor (single) 1712C and processor (multi) 1716C. In some aspects, processors 1712A, 1712B, and 1712C implement functionality similar to a signal and measurement processor (e.g., 1512A or 1612A). In other aspects, processors 1712A, 1712B, and 1712C implement combined functionality similar to a signal and measurement processor (e.g., 1512A or 1612A) and a single tracking processor (e.g., 1504).

As depicted, bus 1717 spans and connects sensors 1701A, 1701B, and 1701C. Sensors 1701A, 1701B, and 1701C can exchange measurements and tracks with one another via bus 1717. Bus 1717 can be a wired, wireless, or other connection. In one aspect, bus 1717 virtually connects sensors 1701A, 1701B, and 1701C.

Within sensor 1701A, scanner 1702A can send pixels 1721A to processor 1712A. Processor 1712A can derive corresponding measurements 1722A (and potentially also tracks) from pixels 1721A. Processor 1712A can put measurements 1722A (and any tracks) onto bus 1717. Bus 1717 can potentially combine measurements 1722A with other measurements (e.g., measurements 1722B, 1722C, etc.) to derive measurements 1724A, which are then forwarded to processor 1716A. Processor 1716A can derive tracks 1726A and/or tracks 1723A from measurements 1724A as well as other measurements (e.g., 1724B, 1724C, etc.) and/or tracks (e.g., tracks 1726B, 1726C, etc.) on bus 1717. Processor 1716A can send tracks 1726A onto bus 1717 and/or send tracks 1723A to exchange 1706. In one aspect, processors 1712A and 1716A are implemented at processor 1703 (of architecture 1700) or another similar processor.

Within sensor 1701B, scanner 1702B can send pixels 1721B to processor 1712B. Processor 1712B can derive corresponding measurements 1722B (and potentially also tracks) from pixels 1721B. Processor 1712B can put measurements 1722B (and any tracks) onto bus 1717. Bus 1717 can potentially combine measurements 1722B with other measurements (e.g., measurements 1722A, 1722C, etc.) to derive measurements 1724B, which are then forwarded to processor 1716B. Processor 1716B can derive tracks 1726B and/or tracks 1723B from measurements 1724B as well as other measurements (e.g., 1724A, 1724C, etc.) and/or tracks (e.g., tracks 1726A, 1726C, etc.) on bus 1717. Processor 1716B can send tracks 1726B onto bus 1717 and/or send tracks 1723B to exchange 1706. In one aspect, processors 1712B and 1716B are implemented at processor 1703 (of architecture 1700) or another similar processor.

Within sensor 1701C, scanner 1702C can send pixels 1721C to processor 1712C. Processor 1712C can derive corresponding measurements 1722C (and potentially also tracks) from pixels 1721C. Processor 1712C can put measurements 1722C (and any tracks) onto bus 1717. Bus 1717 can potentially combine measurements 1722C with other measurements (e.g., measurements 1722A, 1722B, etc.) to derive measurements 1724C, which are then forwarded to processor 1716C. Processor 1716C can derive tracks 1726C and/or tracks 1723C from measurements 1724C as well as other measurements (e.g., 1724A, 1724B, etc.) and/or tracks (e.g., tracks 1726A, 1726B, etc.) on bus 1717. Processor 1716C can send tracks 1726C onto bus 1717 and/or send tracks 1723C to exchange 1706. In one aspect, processors 1712C and 1716C are implemented at processor 1703 (of architecture 1700) or another similar processor.

Exchange 1706 can maintain track history 1711. Machine analytics 1707 and human analytics 1709 (potentially via user 1710) can interact with tracks 1723A, 173B, 1723C, etc. through exchange 1706.

Sensor (Camera) Options

Sensors (e.g., cameras) can include a user-set switch. The user set-switch permits toggling between a loosely coupled mode (generating tracks at the sensor and sending to an exchange) or in a tightly coupled mode (transmitting measurements to a multi-sensor tracker prior to the exchange). When a single sensor is used, tightly coupled and loosely coupled architectures operate similarly, and potentially identically.

Accordingly, in general, imaging object movement can include sensing a Field-of-View (FoV). The FOV can be pixelated into a plurality of pixels. An object can be detected within the plurality of pixels. Measurements can be derived for the detected object. Based on the derived measurements, movement of the object can be tracked within a space (i.e., tracks can be derived). The object can be discretized within the space (e.g., into a dot).

Signal Processing Chains

Aspects of the invention can implement different signal processing chains to image object movement. Signal processing chains can be configured for any of a variety of sensors, including but not limited to: 2D cameras, stereoscopic cameras, lidars, radars (including 2D or 3D radar), sonars (e.g., ultrasonic and including 2D or 3D sonar). 2D cameras provide RGB values for a 2D grid of u,v pixels. Stereoscope cameras are essentially 3D cameras that also provide a “w” (a depth measurement) for each u, v pixel. Lidars are also 3D sensors. Algorithms are flexible per sensor type and a Kalman filter can utilize data from varied sensor types.

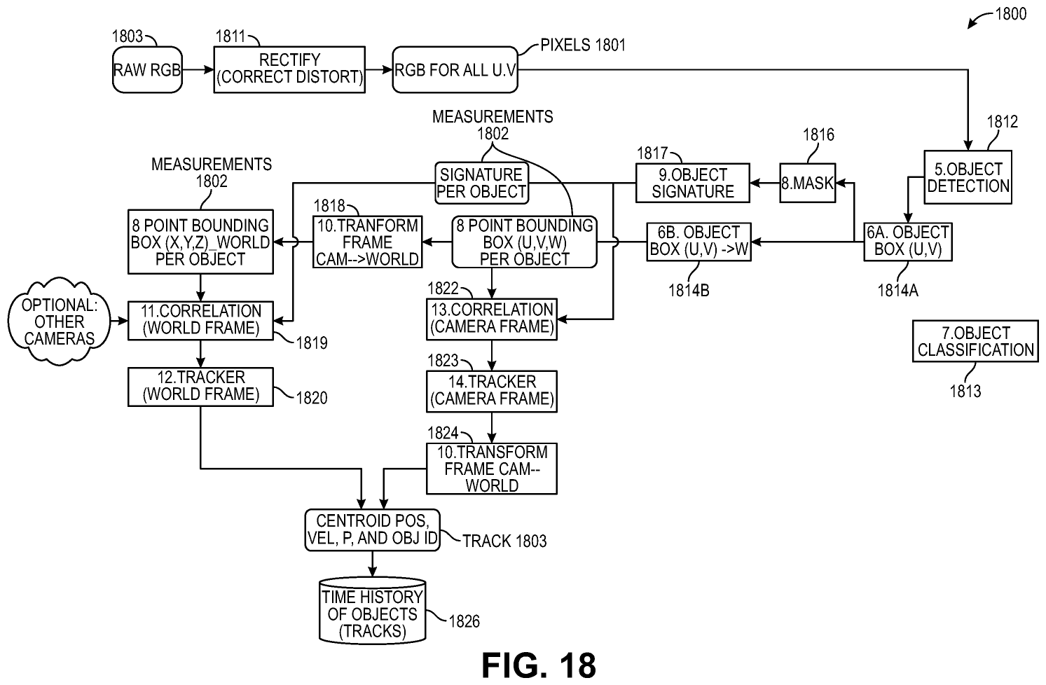

FIG. 18 depicts a signal processing chain 1800 for a 2D camera. As depicted, raw RGB 1803 can be rectified 1811 into pixels 1801 (RGB for all u,v). Objects can be detected from pixels 1801 at object detection 1812. Detected objects can be classified at 1813. An object boxes for detected objects can be derived at 1814A/1814B. Masks for detected objects can be computed at 1816. Object signatures can be derived from computed masks at 1817. Measurements 1802 can be derived from object signatures and objects boxes. More specifically, a signature per object can be derived from object signatures 1817 and an 8 point bounding box can be derived from derived object boxes 1814A/1814B.

8 point bounding boxes can be transformed from camera frame and world frame at 1818. Measurements 1802 can include 8 point bounding boxes in the world frame. 8 point bounding boxes in the world frame can be correlated 1819 with measurements and/or tracks from other cameras 1821. Tracker 1820 can derive tracks from the correlation of 8 point bounding boxes in the world frame. Tracker 1820 can include the tracks in tracks 1803.

8 point bounding boxes in the camera frame can correlated with other tracks at a sensor 1822. Tracker 1823 can derive tracks from the correlation of 8 point bounding boxes in camera frame. Transform 1824 can transform tracks from the camera frame into the world frame. Transform 1824 can include the tracks in tracks 1803.

Tracks 1803 can be stored at time history of objects (tracks) 1826.

In some aspects, distance (“w”) is computed/estimated via neural networks. The computation/estimation via neural networks can replace 1814B.

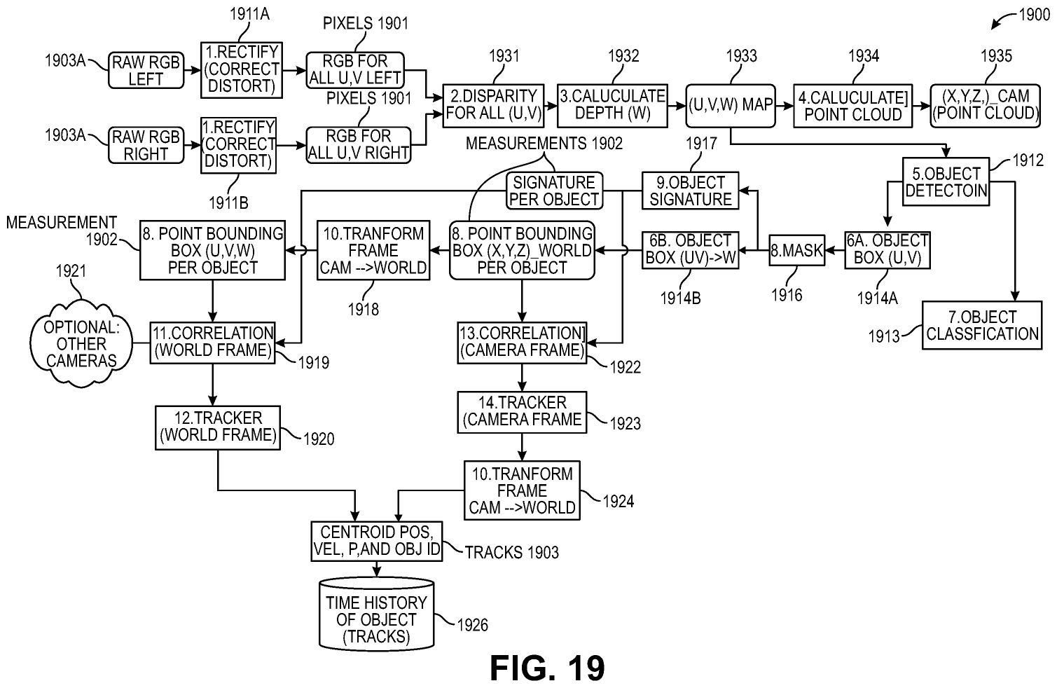

FIG. 19 depicts an example signal processing chain 1900 for a stereoscopic camera.

As depicted, raw RGB 1903A can be rectified 1911A into left pixels 1901 (RGB for all u,v, left). Raw RGB 1903B can be rectified 1911B into right pixels 1901 (RGB for all u,v, right). Disparity for left and right can be calculated at 1931 and used to calculate depth at 1932. From depth a map can be generated at 1933. The map can be used to calculate point cloud 1935 at calculate point cloud 1934.

Objects can be detected from the map at object detection 1912. Detected objects can be classified at 1913. An object boxes for detected objects can be derived at 1914A/1914B. Masks for detected objects can be computed at 1916. Object signatures can be derived from computed masks at 1917. Measurements 1902 can be derived from object signatures and objects boxes. More specifically, a signature per object can be derived from object signatures 1917 and an 8 point bounding box can be derived from derived object boxes 1914A/1914B.

8 point bounding boxes can be transformed from camera frame and world frame at 1918. Measurements 1902 can include 8 point bounding boxes in the world frame. 8 point bounding boxes in the world frame can be correlated 1919 with measurements and/or tracks from other cameras 1921. Tracker 1920 can derive tracks from the correlation of 8 point bounding boxes in the world frame. Tracker 1920 can include the tracks in tracks 1903.

8 point bounding boxes in the camera frame can correlated with other tracks at a sensor 1922. Tracker 1923 can derive tracks from the correlation of 8 point bounding boxes in camera frame. Transform 1924 can transform tracks from the camera frame into the world frame. Transform 1924 can include the tracks in tracks 1903.

Tracks 1903 can be stored at time history of objects (tracks) 1926.

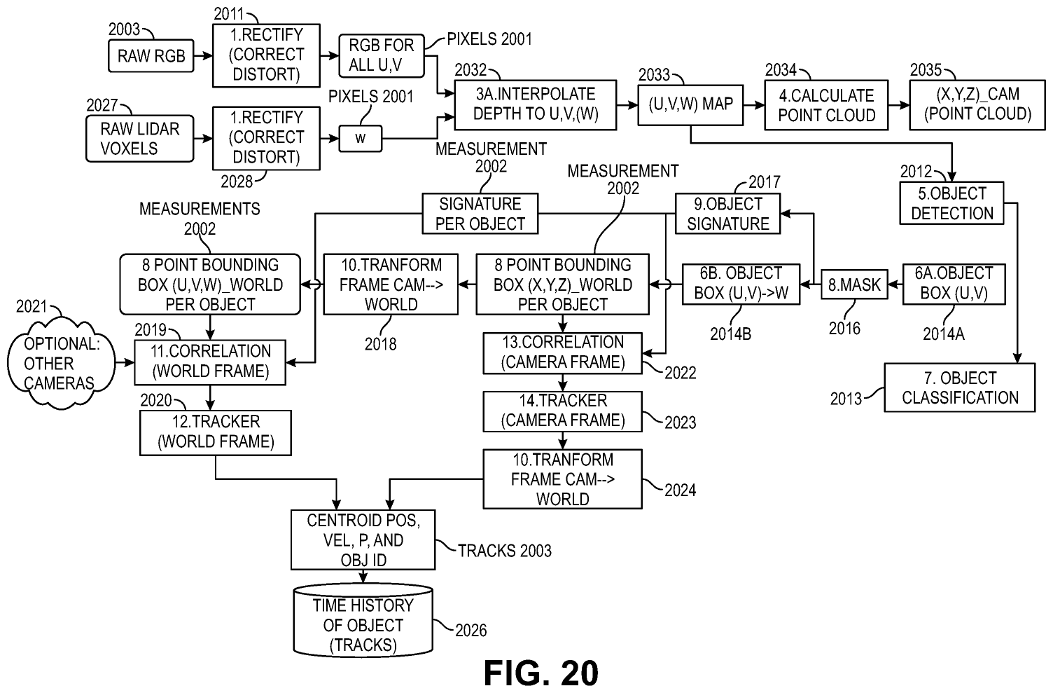

FIG. 20 depicts an example signal processing chain 2000 for a 2D camera with lidar. As depicted, raw RGB 2003 can be rectified 2011 into left pixels 2001 (RGB for all u,v). Raw lidar voxels can be rectified 2028 into right pixels 1901 (w). Depth can be interpreted from pixels 2001 at 2032. From depth a map can be generated at 2033. The map can be used to calculate point cloud 2035 at calculate point cloud 2034.

Objects can be detected from the map at object detection 2012. Detected objects can be classified at 2013. An object boxes for detected objects can be derived at 2014A/2014B. Masks for detected objects can be computed at 2016. Object signatures can be derived from computed masks at 2017. Measurements 2002 can be derived from object signatures and objects boxes. More specifically, a signature per object can be derived from object signatures 2017 and an 8 point bounding box can be derived from derived object boxes 2014A/2014B.

8 point bounding boxes can be transformed from camera frame and world frame at 2018. Measurements 2002 can include 8 point bounding boxes in the world frame. 8 point bounding boxes in the world frame can be correlated 2019 with measurements and/or tracks from other cameras 2021. Tracker 2020 can derive tracks from the correlation of 8 point bounding boxes in the world frame. Tracker 2020 can include the tracks in tracks 2003.

8 point bounding boxes in the camera frame can correlated with other tracks at a sensor 2022. Tracker 2023 can derive tracks from the correlation of 8 point bounding boxes in camera frame. Transform 2024 can transform tracks from the camera frame into the world frame. Transform 2024 can include the tracks in tracks 2003.

Tracks 2003 can be stored at time history of objects (tracks) 2026.

Aspects also include other signal processing chains (e.g., similar to any of the signal processing chains depicted in FIGS. 18, 19, and 20) configured and implemented to image object movement based on other combinations and/or other types of sensors, for example, radar, sonar, etc. These other signal processing chains can use neural networks to compute/estimate distance (“w”).

Computer Architecture

Implementations can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats, such as, for example, between any of: pixels, pixel properties, measurements, measurement properties, tracks, track properties, live views, unified views, alerts, video, video frames, sensors data, user-set criteria, detected objects, object features, object movements, maps, blue prints, dot based representations of objects, reports, analytics, histories, distances, volumes, masks, object boxes, camera frames, world frames, correlations, depths, point clouds, object signatures, etc.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components, such as, for example, pixels, pixel properties, measurements, measurement properties, tracks, track properties, live views, unified views, alerts, video, video frames, sensors data, user-set criteria, detected objects, object features, object movements, maps, blue prints, dot based representations of objects, reports, analytics, histories, distances, volume, masks, object boxes, camera frames, world frames, correlations, depths, points clouds, object signatures, etc.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, sensors, cameras, lidar systems, radar systems, sonar systems, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed.

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A system comprising:
a sensor oriented to sense a Field-of-View (FOV) within at least a portion of a space;
a processor;
system memory coupled to the processor and storing instructions configured to cause the processor to represent a view of object motion within the space, including:
sense the Field-of-View (FoV);
pixelate the Field-of-View (FoV) into a plurality of pixels subsequent to sensing;
detect an object within the plurality of pixels;
derive measurements of the detected object;
based on the derived measurements, derive a track of the object within the space;
discretize the object into a simpler graphical representation of the object; and
represent the track of the object by moving the simpler graphical representation of the object between locations at a user interface.

2. The system of claim 1, further comprising another sensor oriented to sense another Field-of-View (FOV) within at least another portion of the space and further comprising instructions configured to:
sense the other Field-of-View (FoV);
pixelate the other Field-of-View (FoV) into another plurality of pixels;
detect another object within the other plurality of pixels;
derive additional measurements of the other object;
based on the additional measurements, derive a track of the other object within the space;
discretize the other object into a simpler graphical representation of the other object; and
represent the tracked movement of the object by moving the simpler graphical representation of the other object between locations at the user interface.

3. The system of claim 2, further comprising instructions configured to:
exchange the derived measurements with the other sensor via a data bus; and
exchange the other derived additional measurements with the sensor via the data bus.

4. The system of claim 3, further comprising instructions configured to correlate the additional measurements with the track of the object; and
wherein instructions configured to derive a track of the other object within the space comprise instructions configured to update the track of the object within the space.

5. The system of claim 2, further comprising instructions configured to fuse the movement of the object and the movement of the other object.

6. The system of claim 2, wherein the sensor is a camera and the other sensor is one of: another camera, a lidar, a radar, or a sonar, and wherein instructions configured to sense the other Field-of-View (FoV) comprise instructions configured to cause the one of: another camera, a lidar, a radar, or a sonar to sense the other Field-of-View (FoV).

7. The system of claim 1, wherein instructions configured to pixelate the FoV into a plurality of pixels comprises instructions configured to pixelate the FoV into a plurality of Red-Green-Blue (RGB) pixels.

8. The system of claim 1, wherein instructions configured to pixelate the FoV into a plurality of pixels comprises instructions configured to pixelate the FoV into a plurality of Lidar voxels.

9. The system of claim 1, wherein instructions configured to discretize the object into a simpler graphical representation of the object comprises instructions configured to discretize the object into a dot; and
wherein instructions configured to represent the track of the object by moving the simpler graphical representation of the object between locations at a user interface comprise instructions configured to move the dot on a map.

10. The system of claim 1, wherein the space is a worldview, floorplan view, or a contextual view.

11. The system of claim 1, wherein instructions configured to pixelate the FoV into a plurality of pixels comprises instructions configured to pixelate the FoV into a plurality of radar voxels.

12. The system of claim 1, wherein instructions configured to pixelate the FoV into a plurality of pixels comprises instructions configured to pixelate the FoV into a plurality of sonar voxels.

14. The system of claim 1, wherein the sensor is one of: camera, a lidar, a radar, or a sonar.

15. The system of claim 1, further comprising instructions configured to map the simpler graphical representation into a virtual space.

16. The system of claim 1, further comprising instructions configured to synchronize a video feed of the detected object with moving the simpler graphical representation of the object between locations at the user interface.

17. A system comprising:
a first sensor oriented to sense a first Field-of-View (FOV) within at least a first portion of a space;
a second sensor oriented to sense a second Field-of-View (FOV) within at least a second portion of a space;
a processor;
system memory coupled to the processor and storing instructions configured to cause the processor to represent a view of object motion within the space, including:
sense the first Field-of-View (FoV);
pixelate the first Field-of-View (FoV) into a first plurality of pixels subsequent to sensing the first Field-of-View (FoV);
detect an object within the first plurality of pixels;
derive first measurements of the object;
derive a track of the detected object from the first measurements;
sense the second Field-of-View (FoV);
pixelate the second Field-of-View (FoV) into a second plurality of pixels subsequent to sensing the second Field-of-View (FoV);
detect an additional object within the second plurality of pixels;
derive second measurements of the additional object;
correlating the second measurements to the derived track determining the additional object is the object;
update the track of the detected object from the second measurements;
based on the updated track, track movement of the object within the space between the first Field-of-View (FoV) and the second Field-of-View (FoV);
discretize the object into a discretized object within the space; and
represent the tracked movement of the object within the space by moving the discretized object at a user interface.

18. The system of claim 17, wherein instructions configured to derive first measurements of the object comprise instructions configured to derive first measurements of the object at a first time; and
wherein instructions configured to derive second measurements of the additional object comprise instructions configured to derive second measurements of the additional object at a second time, the second time being after the first time.

19. The system of claim 17, further comprising instructions configured to synchronize a video feed of the object with moving the simpler graphical representation of the object between locations at the user interface.
